(19) United States
(12) Patent Application Publication
(10) Pub. No.: US 2005/0191115 A1
(43) Pub. Date: Sep. 1, 2005

(54) Wax application device and method of using same

(76) Inventor: Crystal Heller, Sauk Rapids, MN (US)

Correspondence Address: National IP Rights Center, LLC, Suite 400, 550 Township Line Road, Blue Bell, PA, 19422, US

(21) Appl. No.: 10/788,240

(22) Filed: Feb. 26, 2004

(51) Int. Cl. B43M 1/02; A47L 13/30

(52) U.S. Cl. 401/261; 401/183

(57) ABSTRACT

A wax application device and method of using is disclosed. The wax application device includes a container, for housing wax, and an applicator, mounted on an end of the container, for applying the wax in the container to a surface. The method includes the steps of heating the wax application device, applying the heated wax to a surface, placing a muslin strip to the heated wax, and removing the muslin strip.

### FIELD OF THE INVENTION

The present invention relates to a device for removing hair from the body, and in particular to a wax application device.

### BACKGROUND OF THE INVENTION

Personal hygiene, and in particular the removal of hair from unseemly areas on the body, is a very important need. To this end, a variety of methods of removing body hair have been developed. In particular, the use of wax applied to the hair on the body has been employed as a popular means to remove the hair. Many of these products require that you warm a large portion of wax then apply it with a separate spatula. This requires that the user contain a correct amount of wax onto the spatula and then transport it the area where it will be used, often resulting in the wax dripping in unwanted areas such as on clothing, hands, and other surfaces. Additionally, the wax container must be resealed after use, which is a difficult task when the container and cover are coated with sticky wax.

U.S. Pat. No. 6,478,493 is directed to a depilatory wax stick which is simple, low cost and easy to use, particularly on facial and neck surfaces and other small areas and even in delicate areas where very fine wax deposition is required. In a preferred embodiment disclosed herein, the wax stick is generally cylindrical and is about 10 cm long and has a slightly tapered shape with a 1.8 cm diameter base and a 1.5 cm diameter free end which is rounded to form about a 1.0 cm application tip. Because there is no required flow of wax through an aperture or passage or onto a roller, the stick may be shaped in virtually unlimited ways to facilitate extremely fine application control. In its simplest form, the base of the stick is held in a tapered plastic cap which provides a stable flat surface. An external housing may be provided to promote convenient storage and to prevent contamination of the wax between uses. In an alternative embodiment, the wax stick of the invention is provided in a push-up container much like a lipstick tube which may be capped to enclose the stick.

U.S. Pat. No. 5,803,636 is directed to an applicator for a thermoplastic product, the applicator including: a housing constructed to be held by a user and having a longitudinal axis and an end provided with two mutually parallel longitudinal walls and two transverse walls delimiting a product outlet opening; a reservoir for holding the product, the reservoir being installed in the housing, being constructed to be in thermal communication with a heating unit and being open at one end to permit product in the reservoir to flow into the product outlet opening; an applicator roller located in the product outlet opening and having an axis of rotation which is parallel to the longitudinal walls; and a mechanism for displacing the applicator roller parallel to the longitudinal axis of the housing in order to vary the thickness of a slit through which the thermoplastic product flows out of the applicator.

U.S. Pat. No. 6,076,984 discloses a depilatory wax dispenser having a housing in which is arranged a reservoir for the wax and an applicator device having a roller mounted for rotation on a pivot pin. The pivot pin has two ends which extend through two opposite transverse walls of a rectangular opening provided at the reservoir outlet. The opening has an edge which provides with the roller peripheral surface a slot dispensing melted wax. The opening edge and the roller peripheral surface between which the slot is arranged are made of elastically deformable materials. An element is axially mobile relative to the pivot pin for simultaneously exerting a force on the rectangular opening edge forming the slot and on the roller surface, for deforming them jointly.

U.S. Pat. No. 6,039,482 is directed to a hot wax hair remover apparatus comprising a heating sleeve for depilatory wax equipped with a wax applicator wherein the heating sleeve is provided with a retractable foot equipped with a spring holding the foot in the deployed position and with means for locking the toot in a retracted position, against the force of the spring, controlled by a catch arranged at the base of the sleeve which releases the locking means when the sleeve is put down on a support surface.

U.S. Pat. No. 5,848,850 is directed to an applicator roller for a thermoplastic depilatory wax, the roller being mountable in a wax applicator assembly. The roller includes a wax applicator member and a control device associated with the wax applicator member and operable for causing the wax applicator member to selectively deposit on the skin of a user a band of wax having any one of a plurality of different widths. An applicator for a thermoplastic depilatory wax, the applicator being configured to be held in the hand of a user and including a reservoir for storing a mass of wax, a component for heating the wax and the applicator roller described above.

U.S. Pat. No. 5,873,666 discloses a wax applicator for use in a depilatory waxing procedure. The wax applicator has a body portion with a mounting part for the mounting of the body portion to a wax container. A flow passage leads from the mounting part to a narrow elongate outlet. Wax can flow from the container along the flow passage to the outlet. A spreader is associated with the outlet. The spreader has a distal edge located beyond the outlet so that in use wax issuing form the outlet can spill over the distal edge of the spreader as the applicator is moved forwardly in the direction in which the spreader projects beyond the outlet.

International Application No. WO 98/27845 is directed to an epilatory wax container or device, for example, an applicator, for use in conjunction with said container includes a thermochromic material. The colour change of the thermochromic material provides an indication that the wax in the container is at an appropriate temperature for application to the body.

None of the above devices, however, provides a self contained applicator and wax container that facilitates the use of a wax remover without having to separately heat wax apart from the applicator. Therefore, it would be useful if a wax remover existed that had both the applicator and the wax container in the same unit.

### OBJECTS AND SUMMARY OF THE INVENTION

It is an object of the present invention to provide a wax application device that is self contained.

It is a further object of the present invention to provide a wax application device where the wax container and the applicator are one unit.

It is yet a further object of the present invention to provide a method of removing hair using a wax application device.

In accordance with a first aspect of the present invention, a novel wax application device is provided that is self contained.

In accordance with another aspect of the present invention, a novel self contained wax application device where the container and applicator are one unit is provided. The novel self contained wax application device includes a container, for housing wax, and an applicator, mounted on an end of the container, for applying the wax in the container to a surface.

In accordance with yet another aspect of the present invention, a novel method of removing hair using a wax application device is disclosed. The novel method includes the steps of heating the wax application device, applying the heated wax to a surface, placing a muslin strip to the heated wax, and removing the muslin strip.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a front perspective view of a wax application device in accordance with the present invention.

FIG. 2 is a side elevation view of the wax application device of FIG. 1.

FIG. 3 is a flow diagram of a method of removing hair using a wax application device.

### DETAILED DESCRIPTION OF THE PREFERRED EMBODIMENT

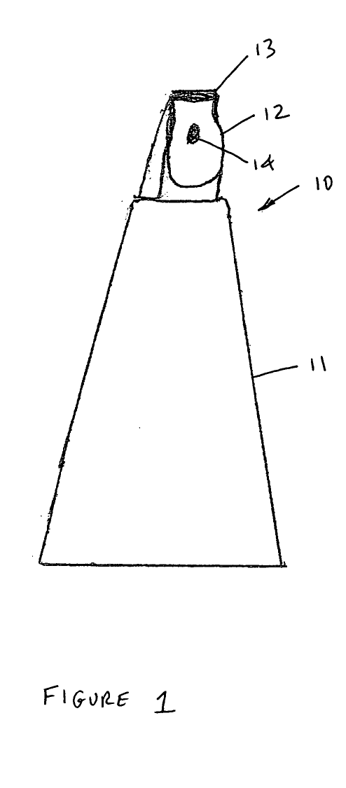

Referring now to the drawings, wherein like reference numerals refer to the same components across the several views and in particular to FIG. 1, there is shown a wax application device 10. The wax application device 10 includes a container 11 and an applicator 12.

The container 11 is, in a preferred embodiment of the present invention, a tube which can be squeezed. Additionally, the container 11 is filled with wax and is formed of a heat resistant plastic, capable of being heated up without damage to the container 11. The applicator 12 is mounted on an end of the container 11 so as to facilitate transferring wax in the container 11 to a surface, such as the skin of a person to remove hair.

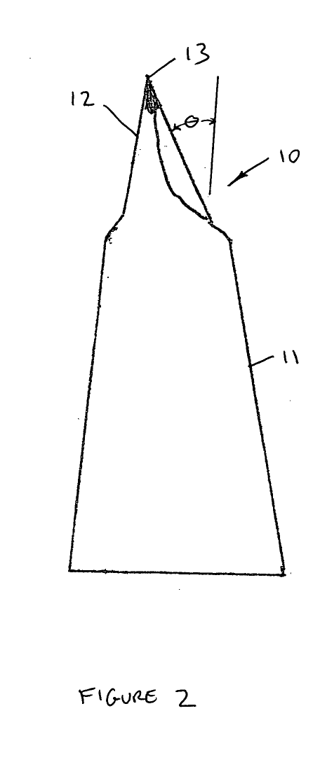

The applicator 12 has a spatula 13 mounted on it to spread the wax in the container 11, and a hole 14, through which the wax is expelled from the container 11. As illustrated in FIG. 2, the applicator 12 has a slant θ which, in a preferred embodiment is 550. However, any slant known to one of ordinary skill in the art may be employed on applicator 12. The slant θ allows for easier application of the wax onto the surface. The spatula 13, mounted on the applicator 12 can be used to spread the wax onto the surface once it is forced through the hole 14 of the applicator 12.

The applicator 12, in a preferred embodiment is either 4 millimeters or 8 millimeters. The 4 millimeter applicator 12 is typically used for facial hair removal in small areas, such as eyebrows. The 8 millimeter applicator 12 is typically used for larger applications, such as on the lips and chin. Furthermore, the 4 millimeter applicator 12 has a 2 millimeter hole 14 and the 8 millimeter applicator 12 has a 3 millimeter hole 14, through which the wax is squeezed.

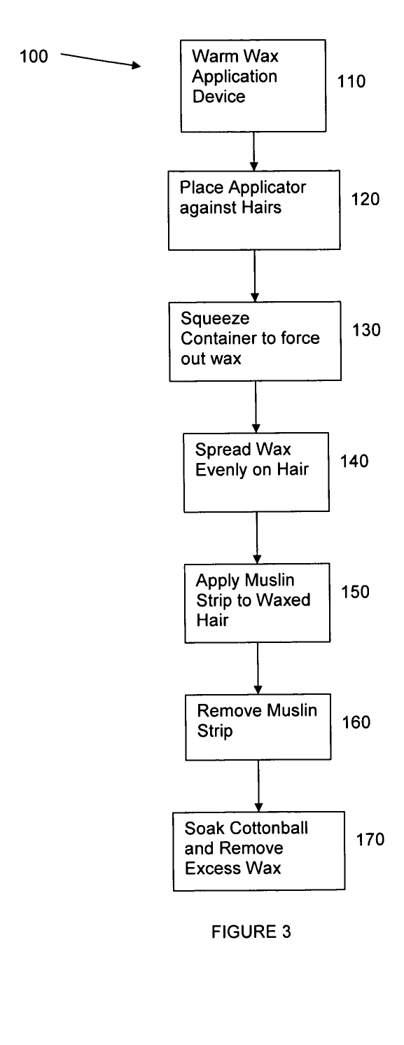

Referring now to FIG. 3, a method for removing hair 100 using the wax application device 10 is illustrated. In step 110, the tube wax application device 10 is warmed to make the wax inside soft and pliable. The warming can be done, for example, by placing the wax application device 10 in hot tap water, or in a microwave. However, any means of warming known to one of ordinary skill in the art may be used. In step 120, the user places the applicator 12 against the hairs she wants to remove, and in step 130 squeezes the container 11 to force wax out through the hole 14 of the applicator 12 onto the hairs. The user then spreads the wax evenly on the hair using the spatula 13 of the applicator 12 in step 140. In step 150, a muslin strip is applied to the wax on the hair. The user removes the muslin strip in the opposite direction in step 160 in order to lift the wax and the hair out of the skin. A cotton ball is then soaked in wax removal oil and any residue of wax is wiped away in step 170. The container 11 can then be disposed of if desired.

In view of the foregoing disclosure, some advantages of the present invention can be seen. For example, a novel wax application device is disclosed. The wax application device has a container and applicator housed in one unit so that one need not separately heat the container of wax and then try to transport the wax from the container to the application area. Additionally, a novel method of removing hair using a wax application device is disclosed.

While the preferred embodiment of the present invention has been described and illustrated, modifications may be made by one of ordinary skill in the art without departing from the scope and spirit of the invention as defined in the appended claims. For example, in a preferred embodiment of the present invention, a tube is described as the container for the wax. However, any type of container known to one of ordinary skill in the art may be employed to house the wax. Additionally, in a preferred embodiment of the present invention, the use of a muslin strip has been described to place on the wax to then be removed. However, any type of strip known to one of ordinary skill in the art may be employed to remove the wax from the hair. For example, instead of muslin strips, alternatively felt paper could be used.

1. A wax application device, comprising:
a container, for housing wax; and
an applicator, mounted on an end of the container, for applying the wax in the container to a surface.

2. The wax application device of claim 1, further comprising a spatula, mounted on the applicator for applying the wax.

3. The wax application device of claim 2 wherein the container is a tube.

4. The wax application device of claim 1, wherein the applicator includes a hole built into the applicator.

5. The wax application device of claim 4, wherein the hole is built into the applicator at a slant.

6. The wax application device of claim 5, wherein the applicator is 4 millimeters.

7. The wax application device of claim 6, wherein the hole built in the applicator is 2 millimeters.

8. The wax application device of claim 5, wherein the applicator is 8 millimeters.

9. The wax application device of claim 8, wherein the hole built in the applicator is 3 millimeters.

10. A method of removing hair with the wax application device of claim 1, comprising the steps of:
heating said wax application device;
applying the heated wax to a surface;
allowing said wax to cool: and
removing said wax from said surface.

11. The method of claim 10, further comprising the steps of:
soaking a cotton ball in wax removal oil; and
wiping away wax residue.

12. The method of claim 11, further comprising the step of disposing of the wax application device.

13. A method of removing hair with the wax application device of claim 1, comprising the steps of:
heating said wax application device;
applying the heated wax to a surface;
placing a piece of felt paper to said heated wax; and
removing said piece of felt paper.

14. The method of claim 13, further comprising the steps of;
soaking a cotton ball in wax removal oil; and
wiping away wax residue.

15. The method of claim 14, further comprising the step of disposing of the wax application device.
